(19) United States
(12) Patent Application Publication
(10) Pub. No.: US 2020/0040949 A1
(43) Pub. Date: Feb. 6, 2020

(54) BLADE WHEEL CONTOUR

(71) Applicant: VOITH PATENT GMBH, HEIDENHEIM (DE)

(72) Inventors: HARALD HOFFELD, CRAILSHEIM (DE); BERNHARD SCHUST, KRESSBERG (DE)

(21) Appl. No.: 16/338,537

(22) PCT Filed: Jul. 5, 2017
(86) PCT No.: PCT/EP2017/066741

§ 371 Date: Apr. 1, 2019

(30) Foreign Application Priority Data
Sep. 30, 2016 (DE) 10 2016 118 588.4

(51) Int. Cl. F16D 33/06; A01D 67/00

(52) U.S. Cl. CPC F16D 33/06; F16D 33/20; A01D 67/00

(57) ABSTRACT

A hydrodynamic coupling contains a pump wheel and a turbine wheel, which are rotatably mounted about a common axis of rotation. The pump wheel and the turbine wheel each carry a circumferential channel about the axis of rotation, so that the channels axially facing one another limit a toroidal working space that can be filled with a fluid. The pump wheel and the turbine wheel each have radial blades which subdivide the channels into blade chambers. Here, the turbine wheel has a first blade chamber and a second blade chamber, wherein contours of the channel in the radial direction are distinct in the two blade chambers.

The invention relates to a hydrodynamic coupling. In particular, the invention relates to the contour of a blade chamber on a blade wheel of the hydrodynamic coupling.

A hydrodynamic coupling is equipped in order to transmit a torque between an input side and an output side. The input side and the output side are each connected to at least one blade wheel, wherein the blade wheel of the driven side (the input side) is also referred to as pump wheel and the blade wheel of the driving side (the output side) is also referred to as turbine wheel. Between the blades of the two blade wheels a fluid acts on the wheels in a hydrodynamically coupling manner, so that a certain slip between the input side and the output side is possible, i.e. rotational speeds of the input side and of the output side differ from one another. A degree of coupling between the pump wheel and the turbine wheel can be influenced by the amount of fluid that is present in the region between the blade wheels. For controlling the fluid quantity, a fluid system is usually provided or is determined with the initial fill upon commissioning.

The coupling system can be used for example for transmitting torque between a drive motor and a belt conveyor (also referred to as conveyor belt). For starting the belt it can be required to gently or slowly increase the force acting on the belt in order to avoid overloading. The greater the load is on the belt, the more cautiously the conveying force on the belt will have to be built up. When the belt is used for example for conveying overburden in open-pit mining, the start-up from the stationary state until reaching a usual conveying speed can take up several minutes.

An object on which the present invention is based consists in providing an improved hydrodynamic coupling for the even transmission of torque. A further object consists in stating an improved coupling system with such a coupling. The invention solves these objects by means of the objects of the independent claims. Subclaims reflect preferred embodiments.

A hydrodynamic coupling comprises a pump wheel and a turbine wheel, which are rotatably mounted about a common axis of rotation. The pump wheel and the turbine wheel each carry a circumferential channel about the axis of rotation, so that the channels axially facing one another limit a toroidal working space that can be filled with a fluid. The pump wheel and the turbine wheel each comprise radial blades which subdivide the channels into blade chambers. Here, the turbine wheel comprises a first blade chamber and a second blade chamber and contours of the channel in the radial direction are distinct in the two blade chambers.

By way of the different contours, the two blade chambers can be optimized for different purposes. For example, the first blade chamber can be designed for maximizing the volume of the working space, while the second blade chamber can have a special swirl chamber profile, which can in particular influence the behavior of the hydrodynamic coupling in the case of higher degrees of slip. By maximizing the working space volume, the performance density and/or the maximally transmittable torque can be increased relative to another hydrodynamic coupling with the same outer diameter, same blade angle (usually 90° for both directions of rotation), same rotational speed and same specific weight of the fluid. By means of the contour of the second blade chamber, a flow behavior of the fluid can be influenced in particular in the radial direction. With rising degree of slip, this flow can be more greatly influenced by means of the second contour, so that the torque build-up during the start-up of the coupling can be influenced in an improved manner. Effectively, a particularly gentle start-up with a slow build-up of force can be realized. Torque peaks can be effectively dampened.

The first blade chamber has a first longitudinal section area and the second blade chamber a second longitudinal section area. The longitudinal section area lies in a plane with the axis of rotation. It is preferred that the second longitudinal section area is larger than the first longitudinal section area. The size of the longitudinal section area is substantially controlled by the contour of the channel in the region concerned. With increasing size of the longitudinal section area, the volume of the blade wheel increases and thus the volume of the working wheel.

By maximizing the working space volume, the mass flow between the pump wheel and the turbine wheel can be increased so that transmittable power is increased as was described above.

It is preferred, furthermore, that all blade chambers of the turbine wheel either correspond to the first or the second blade chamber. In other words, it is preferred that the turbine wheel comprises first and second blade chambers, wherein the first blade chambers correspond to one another and the second blade chambers correspond to one another. The correspondence is effected preferably with regard to the contour of the channel and thus also with regard to the size and shape of the longitudinal section area. It is preferred, furthermore, that blade chambers of the same type have same extensions in the circumferential direction, so that their volumes likewise correspond to one another. Further preferably, all blade chambers have same extensions in the circumferential direction.

The second blade chamber can be subdivided into a radially inner and a radially outer region. A curvature of the channel or of the contour in the radial direction is preferably greater in the outer region than in the inner region. In other words, a minimal curvature radius of the contour in the outer region is smaller than in the inner region. The contour lies in the longitudinal section plane and therefore limits the longitudinal section area. In a manner of speaking, the contour is formed rounder in the inner region and more angular in the outer region. Because of this, the objectives with regard to the maximization of the working space volume and the control of the fluid flow by swirling described above can each be improved.

The partition between the inner and the outer region is generally uncritical and can be selected in different ways. In a preferred embodiment, the partition is selected in such a manner that volumes of the inner and of the outer region of a second blade chamber are substantially identical in size. Here, the partition extends along a cylindrical partition area about the axis of rotation. In another preferred embodiment, the cylindrical partition area extends through a point which extends halfway between the largest outer radius and the smallest inner radius of the blade chamber. In yet a further embodiment, the partition area extends through a centroid of an area of the longitudinal section area of the blade chamber concerned. In yet a further embodiment, the partition area can also extend through a centroid of an area of an area, which corresponds to a longitudinal section through the torus. In all embodiments, an inner and an outer region directly adjoin one another in the radial direction and the curvature of the contour is greater in the outer region than in the inner region.

It is preferred, furthermore, that a section of the contour in the outer region extends in a straight line and substantially in the radial direction. Compared with a usual course of the profile that is substantially curved continuously or evenly, the intended influencing of the flow of the fluid can thereby be realized.

In addition it is preferred that a section of the contour in the outer region extends in a straight line and substantially in the axial direction. This section can limit the blade chamber on the radially outer side. In a particularly preferred embodiment, this section encloses a small angle with the axis of rotation in the range from approximately 0 to 5°, preferably approximately 3°. By way of the section of the contour that is routed straight, the flow of the fluid can be influenced as was described above. By selecting a positive small angle between the section and the axis of rotation, material can be saved in the radial outer region of the turbine wheel.

A transition between the described sections can in particular follow a predetermined radius. This radius can in particular correspond to the minimal curvature radius that was described above. Thus, a transition in the shape of an arc of a circle lies between the two sections, which transition in extension can form a fillet about the axis of rotation.

The contour of the channel in the blade wheels of the pump wheel can be substantially constant. In particular, the contour can follow a known contour, for example the so-called Chrysler profile. However it is preferred that the curvature of the channel of the pump wheel is substantially constant in the radial direction. A profile to which this characteristic applies is known as the XL-profile. Compared with the Chrysler profile, a first enlargement of the working space volume was achieved here.

It is generally preferred that the first blade chambers and the second blade chambers are each evenly distributed over the circumference about the axis of rotation, so that a sequence of first and second blade chambers in the circumferential direction is always identical. Here it is preferred in particular that the blade chambers also have same extensions in the circumferential direction.

In a further preferred embodiment, more first than second blade chambers are provided on the turbine wheel. For example, a third, half or a quarter of the blade chambers can each be embodied in the manner of the second blade chamber described above, while the remaining blade chambers are embodied in the manner of the first blade chamber described above.

It is preferred, furthermore, that on the turbine wheel a throttle disk is attached, which lies coaxially to the axis of rotation and partly covers the first and second blade chambers from radially inside. Axially, the throttle disk preferably lies on an axial side facing the turbine wheel. By way of the throttle disk, the circular flow of the fluid within the torus can be progressively disturbed with increasing slip so that the maximum transmittable torque between the input side and the output side can be securely and reproducibly limited. The amount of the limitation can be adjusted by the outer diameter of the throttle disk. The larger this outer diameter is, the smaller is the maximum torque that can be transmitted via the hydrodynamic coupling.

A fill-controlled coupling system comprises the coupling described above and a fluid system for controlling a quantity of fluid that is present in the working space. In an embodiment, the fluid is circulated between the working space and a tank, wherein the fluid preferably comprises an oily liquid. In another embodiment, a fluid flows through the coupling, wherein fluid that escapes from the working space is disposed of and not conveyed back into the working space. This embodiment is preferably operated with a watery liquid. The watery liquid can be advantageously used in particular in explosion-threatened surroundings, for example underground. Water or a similar watery liquid can have a higher specific heat capacity than an oily liquid, so that a reduced flow rate of the fluid can be required for the heat dissipation.

Compared with an identically sized conventional coupling, the coupling described above can transmit a greater torque. A cavitation on flow edges, for example with high slip rates and when using water as fluid, can occur more rarely because of the contours employed. Using a material, for example propeller bronze, that is more resistant to cavitation erosion, may not be necessary because of this. Bronze is generally more resistant to cavitation erosion than light metal but is heavier and more expensive to process.

The invention is now described in more detail with regard to the attached figures, in which:

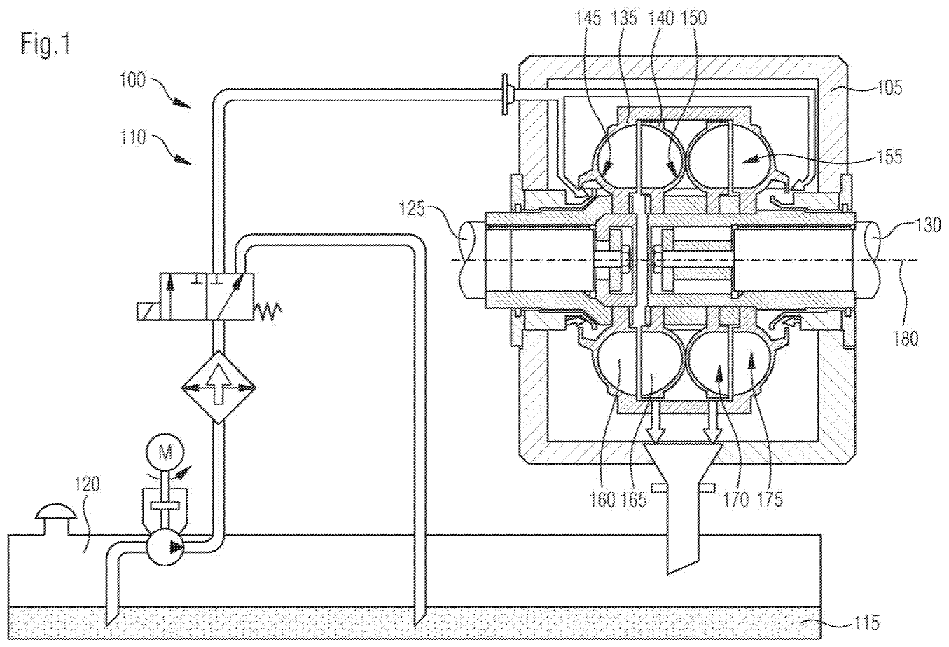

FIG. 1 shows a coupling system with a fill-controlled hydrodynamic coupling;

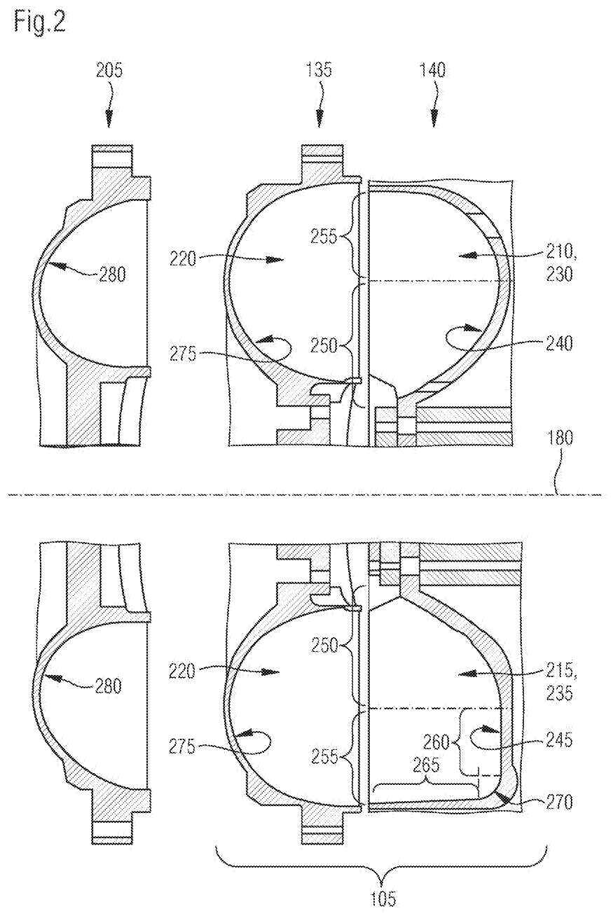

FIG. 2 shows contours of different blade wheels of the coupling from FIG. 1 in longitudinal section;

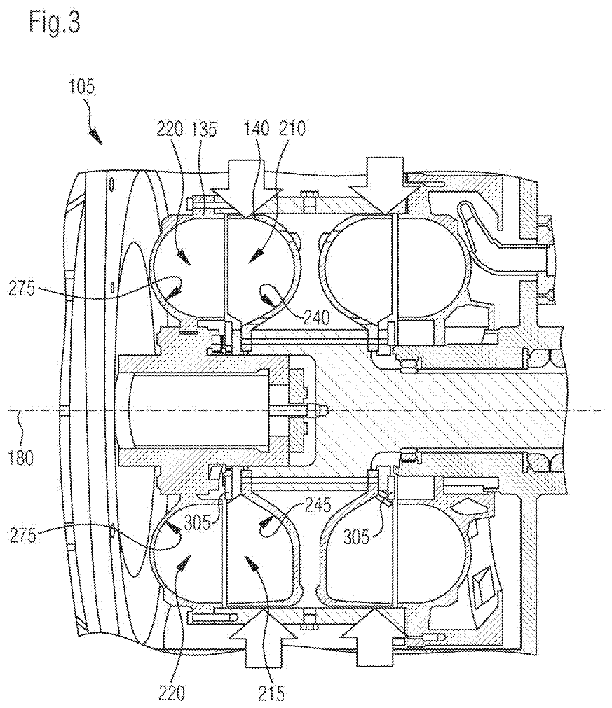

FIG. 3 shows a coupling in longitudinal section;

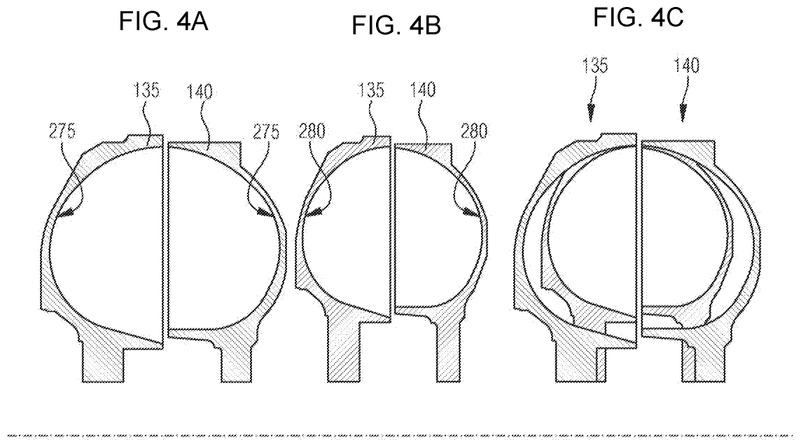

FIG. 4 shows a comparison of contours on blade wheels; and

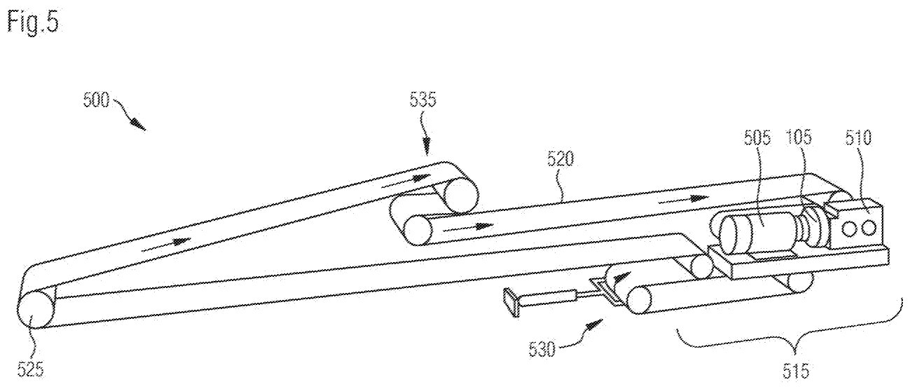

FIG. 5 shows a belt conveyor with the coupling from FIG. 1.

FIG. 1 shows a coupling system 100 with a fill-controlled hydrodynamic coupling 105. In addition to the coupling 105, the coupling system 100 comprises a fluid system 110 in order to control a quantity of fluid 115 that is present in the coupling 105. The shown fluid system 110 causes a cyclical circulation of fluid 115 between the coupling 105 and a fluid tank 120. In another preferred embodiment, the coupling 105 is configured as a fluid coupling, in which no circulation of fluid 115 takes place. The fluid 115 can comprise an oily liquid, in particular in the case of a circulative fluid system 110, or a water liquid, in particular with a fluid-type coupling 105.

The coupling 105 is equipped in order to transmit a torque between an input side 125 and an output side 130. The coupling 105 comprises a pump wheel 135, which is connected to the input side 125, and a turbine wheel 140, which is connected to the output side 130. In the embodiment of FIG. 1, two pump wheels 135 and two turbine wheels 140 are provided, wherein the pump wheels 135 lie axially between the turbine wheels 140; in other embodiments, the coupling 105 merely comprises one pump wheel 135 and one turbine wheel 140. On the pump wheel 135, a pump channel 145 and on the turbine wheel 140 a turbine channel 150 are formed. Open sides of the channels 145, 150 face one another in axial directions. Accordingly, the channels 145, 150 limit a toroidal working space 155, which can be filled with fluid 115. On the pump wheel 135, pump blades 160 and on the turbine wheel 140, turbine blades 165 are provided, wherein the blades 160, 165 each extend in the radial direction through the toroidal working space 155 in order to form blade chambers lying next to one another in the circumferential direction.

When there is a slip between the input side 125 and the output side 130, the fluid 115 in the working space 155 is helically exchanged along the torus between blade chambers on the pump wheel 135 and on the turbine wheel 140. The torque coupling between the input side 125 and the output side 130 is stronger the more fluid 115 is accommodated in the working space 155. A maximum torque can be transmitted between the input side 125 and the output side 130 when the working space 155 is completely filled with fluid 115.

The amount of the transmittable torque is dependent on multiple factors. Generally, the power density of the coupling 105 can be increased by enlarging a mass flow of fluid 115 that is exchanged between the pump wheel 135 and the turbine wheel 140. For this purpose, the volume of the working space 155 can be maximized. This volume is dependent on how the pump blades 170 and the turbine blades 175 are shaped. The shape of the pump blades 170 and of the turbine blades 175 can be evaluated by way of the shown longitudinal section through the coupling 105, wherein the longitudinal section extends through an axis of rotation 180, with respect to which the pump wheel 135 and the turbine wheel 140 are coaxially mounted.

FIG. 2 shows contours of different blade wheels of the coupling 105 of FIG. 1 in longitudinal section. In an illustrative manner, sections of an exemplary pump wheel 135 and of an exemplary turbine wheel 140 which, with respect to the axis of rotation 180 are located opposite, are shown. For comparative purposes, a known pump wheel 205 is additionally shown in a similar representation.

It is proposed that the turbine wheel 140 comprises differently shaped blade chambers. In the upper region of FIG. 2, a first blade chamber 210 and in the lower region a second blade chamber 215 of the turbine wheel 140 are shown. The first blade chamber 210 limits a first longitudinal section area 230 and the second blade chamber 215 a second longitudinal section area 235. The longitudinal section areas 230, 235 are those area sections which are each defined by the blade chambers 210, 215 in a plane which includes the axis of rotation 180. On an axial side, which faces away from the pump wheel 135, the first longitudinal section area 230 is limited by a first contour 240 and the second longitudinal section area 235 by a second contour 245. The pump wheel 135 preferably comprises blade chambers 220 that are identical in shape.

The second blade chamber 215 differs from the first blade chamber 210 primarily by the shape of the second contour 245 compared with the first contour 240. During its course in the radial direction, the second contour 245 passes through a greater curvature than the first contour 240. Generally, it is preferred that the second contour 245 is longer than the first contour 240. Usually, the second longitudinal section area 235 is larger than the first longitudinal section area 230 because of this.

The blade chambers 210 and 215 can each be subdivided into a radially inner region 250 and a radially outer region 255. The subdivision is defined by their distance from the axis of rotation 180, so that a partition area between the inner region 250 and the outer region 255 is cylindrical with respect to the axis of rotation 180. It is preferred that the second contour 245, which limits the second blade chamber 215, is curved more in the outer region 255 than in the inner region 250. In other words it is preferred that a minimum curvature radius of the second contour 245 along its course is smaller in the outer region 255 than in the inner region 250. The shape of the second contour 245 in the inner region 250 can correspond to the shape of the first contour 240 in the inner region 250. The radial distance from the axis of rotation 180, at which the inner region 250 adjoins the outer region 255, can be determined in different ways. In an embodiment, the distance is selected so that volumes of the inner region 250 and of the outer region 255 in the second blade chamber 215 are substantially identical in size. Alternative possibilities of determining the distance are explained in more detail above.

It is preferred that the second contour 245 in the outer region 255 has a first section 260 which extends substantially in a straight line. The extension direction preferably extends in the radial direction, i.e. encloses an angle of approximately 90° with the axis of rotation 180. In addition to this it is preferred that the second contour 245 comprises a second section 265 which likewise extends substantially in a straight line. Here, the extension direction extends at least approximately parallel to the axis of rotation 180. In a preferred embodiment, the extension direction includes an angle of approximately 3° with the axis of rotation 180. A third section 270 of the second contour 245 further preferably lies between the first section 260 and the second section 265, wherein the third section 270 preferably follows a predetermined radius.

It is preferred that on the turbine wheel 140 multiple first blade chambers 210 of the same type and multiple second blade chambers 215 of the same type are formed. Preferably, more first blade chambers 210 than second blade chambers 215 are provided. It is preferred, furthermore, that a sequence of first and second blade chambers 210, 215 is even in the circumferential direction. This is possible when the total number of blade chambers 210, 215 without remainder can be divided by the number of second blade chambers 215. When for example the total number of the blade chambers 210, 215 of the turbine wheel 140 can be divided by four, each fourth blade chamber can be formed as a second blade chamber 215, wherein the remaining blade chambers are formed as first blade chambers 210.

The first contour 240, which limits the first blade chamber 210, and in particular the second contour 245, which limits the second blade chamber 215, are further developments of a so-called XL-contour 275 (also called XL-profile), which is visible on the pump wheel 135 in the representation of FIG. 2. The XL-contour 275 has a substantially constant curvature in its radial extent. In contrast with this, a curvature of a Chrysler contour 280, which is visible on the pump wheel 205, is dependent in its curvature on a radial distance from the axis of rotation 180 to a greater extent. The XL-contour 275 was developed as an optimization of the Chrysler contour 280 for enlarging the volume of the working space 155.

FIG. 3 shows a longitudinal section through an exemplary coupling 105. It becomes clear that all blade chambers 220 of the pump wheel 135 are limited by the same XL-contour 275 while the turbine wheel 140 comprises first blade chambers 210 with a first contour 240 and second blade chambers 215 with a second contour 245.

In a further preferred embodiment, a throttle disk 305 is attached to the turbine wheel 140. The throttle disk 305 lies coaxially to the axis of rotation 180 and from radially inside covers a part of the blade chambers 210 and 215. The larger an outer diameter of the throttle disk 305 is, the larger is the coverage and the greater is the degree to which fluid 115 is prevented from an exchange between a turbine wheel-side blade chamber 210, 215 and a pump wheel-side blade chamber 220. The throttle disk 305 can be dimensioned in order to limit the maximum torque that can be transmitted via the coupling 105. It is preferred that the throttle disk 305 is dimensioned relatively small in order to allow a large maximally transmittable torque.

FIG. 4 shows a comparison of different contours on pump wheels 135 and turbine wheels 140. FIG. 4A shows a pump wheel 135 and a turbine wheel 140, which each have the XL-contour 275. FIG. 4B shows a pump wheel 135 and a turbine wheel 140 which each have a Chrysler contour 280. FIG. 4C shows the representations of the FIGS. 4A and 4B superimposed. The representations should be seen as exemplary and not necessarily to scale.

FIG. 5 shows a belt conveyor 500 with the coupling 105 from FIG. 1. The coupling 105 is arranged between an electric drive motor 505 and a transmission 510. The drive motor 505, the coupling 105 and the transmission 510 together form a drive station 515, on which a conveyor belt 520 can be driven by means of a roller. The drive station 515 preferably lies at an end of a section to be spanned by means of the conveyor belt 520. At the other end, a deflection roller 525 is located. Usually, a tensioning device 530 is provided in order to tension the conveyor belt 520 in the longitudinal direction. Depending on the case of application, one or more intermediate drives 535 can be additionally provided between the ends of the section. Each intermediate drive 535 can comprise a drive station with a drive motor 505, a transmission 510 and a coupling 105.

The coupling 105 described above is particularly suited for use on the belt conveyor 500, since through the described hydrodynamic configuration, a particularly even transmission and gentle increasing or controlling of the torque transmitted via the coupling 105 is possible.

### LIST OF REFERENCE NUMBERS

100 Coupling system
105 Coupling
110 Fluid system
115 Fluid
120 Fluid tank
125 Input side
130 Output side
135 Pump wheel
140 Turbine wheel
145 Pump channel
150 Turbine channel
155 Working space
160 Pump blade
165 Turbine blade
170 Pump blade
175 Turbine blade
180 Axis of rotation
205 Pump wheel with Chrysler profile
210 First blade chamber of the turbine wheel
215 Second blade chamber of the turbine wheel
220 Blade chamber of the pump wheel
230 Longitudinal section area of the first blade chamber
235 Longitudinal section area of the second blade chamber
240 First contour
245 Second contour
250 Inner region
255 Outer region
260 First section
265 Second section
270 Third section
275 XL-contour
280 Chrysler contour
305 Throttle disk
500 Belt conveyor
505 Drive motor
510 Transmission
515 Drive station
520 Conveyor belt
525 Deflection roller
530 Tensioning device
535 Intermediate drive

1-15. (canceled)

16. A hydrodynamic coupling, comprising:
a pump wheel;
a turbine wheel, said pump wheel and said turbine wheel being rotatably mounted about a common axis of rotation;
said pump wheel and said turbine wheel each carrying a circumferential channel about the common axis of rotation, said circumferential channel of said pump wheel and of said turbine wheel define channels axially facing one another and limit a toroidal working space that can be filled with a fluid;
said pump wheel and said turbine wheel each having radial blades which subdivide said channels into blade chambers; and
said blade chambers of said turbine wheel include a first blade chamber and a second blade chamber, and said circumferential channel having contours in a radial direction being distinct in said first and second blade chambers.

17. The coupling according to claim 16, wherein said first blade chamber has a first longitudinal section area and said second blade chamber has a second longitudinal section area and said second longitudinal section area is larger than said first longitudinal section area.

18. The coupling according to claim 16, wherein all of said blade chambers of said turbine wheel either correspond to said first blade chamber or said second blade chamber.

19. The coupling according to claim 16, wherein said second blade chamber has a radially inner region and a radially outer region and a curvature of said circumferential channel in the radial direction is greater in said radially outer region than in said radially inner region.

20. The coupling according to claim 19, wherein a partition between said radially inner region and said radially outer region is selected in such a manner that volumes of said radially inner region and of said radially outer region in said second blade chamber are substantially identical.

21. The coupling according to claim 19, wherein a section of a contour in said radially outer region extends in a straight line and substantially in the radial direction.

22. The coupling according to claim 21, wherein a section of a contour in said radially outer region extends in a straight line and substantially in an axial direction.

23. The coupling according to claim 22, wherein a transition between said section in said radially outer region and said section in said radially inner region follows a predetermined radius.

24. The coupling according to claim 16, wherein in said blade chambers of said pump wheel a curvature of said circumferential channel in the radial direction is substantially constant.

25. The coupling according to claim 16, wherein said first blade chamber is one of a plurality of first blade chambers and said second blade chamber is one of a plurality of second blade chambers, said first blade chambers and said second blade chamber are each evenly distributed over a circumference about the common axis of rotation, so that a sequence of said first and second blade chambers in a circumferential direction is always identical.

26. The coupling according to claim 25, wherein more of said first blade chambers than said second blade chambers are provided.

27. The coupling according to claim 16, further comprising a throttle disk attached on said turbine wheel, said throttle disk lying coaxially to the common axis of rotation and partly covers said first and second blade chambers from radially inside.

28. A fill-controlled coupling system, comprising:
a coupling, containing:
a pump wheel;
a turbine wheel, said pump wheel and said turbine wheel being rotatably mounted about a common axis of rotation;
said pump wheel and said turbine wheel each carrying a circumferential channel about the common axis of rotation, said circumferential channel of said pump wheel and of said turbine wheel define channels axially facing one another and limit a toroidal working space that can be filled with a fluid;
said pump wheel and said turbine wheel each having radial blades which subdivide said channels into blade chambers; and
said blade chambers of said turbine wheel include a first blade chamber and a second blade chamber, and said circumferential channel having contours in a radial direction being distinct in said first and second blade chambers; and
a fluid system for controlling a quantity of the fluid present in said toroidal working space.

29. The fill-controlled coupling system according to claim 28, wherein the fluid has a watery liquid.

30. The fill-controlled coupling system according to claim 28, wherein said turbine wheel can be produced from metal.
